(19) United States
(12) Patent Application Publication
(10) Pub. No.: US 2013/0239448 A1
(43) Pub. Date: Sep. 19, 2013

(54) PROCESS FOR PERSONALIZING DIGITAL MEDIA GREETINGS

(71) Applicant: Leonard Davis, Palmdale, CA (US)

(72) Inventor: Leonard Davis, Palmdale, CA (US)

(21) Appl. No.: 13/418,902

(22) Filed: Mar. 13, 2012

(51) Int. Cl. G09F 1/00

(52) U.S. Cl. 40/124.03

(57) ABSTRACT

A personalized greeting from a celebrity or well-known figure for use in greeting cards, gift, or consumer type products, is recorded and stored in digital media for application to a consumer product such as a greeting card. The greeting can consist of speech, music, or both, and is in the unique and personal style of the celebrity or well-known figure. Graphics may be included that can be a picture of the celebrity or well-known figure or a written greeting. A code may also be provided with the consumer product to enable access to free information on the internet about the greeting, the celebrity or well-known figure.

### BACKGROUND OF THE INVENTION

Gift giving has a long world-history. Gifts are given for special occasions and events and are used to signify love, respect, admiration, or accomplishment. Similarly, greeting cards have also become a common way to express sentiments, without the same expense that a gift can incur. The custom of giving greeting cards became popular in the mid 1800's as advances in printing technology and the postal system made greeting cards easier to procure and send.

By the 1980's alternative style greeting cards, featuring humorous pictures and text had become extremely popular, and people were sending greeting cards for a wide array of events beyond traditional holidays and birthdays. The most recent permutation on the greeting card includes an interactive electronic component as featured in several patent application publications.

U.S. Patent Publication US 2008/0016731 to Branch discloses a greeting card that uses a sound device to play the tune of a song. One embodiment of Branch teaches a greeting card printed with lyrics from a song that is played by the attached sound device. Branch, however, does not teach a greeting card or gift that is printed with pictures of a celebrity. Similarly, Branch does not allow for recorded greetings that are just spoken rather than musical. Branch also does not allow for an additional recording from the gift or card giver to be tacked on to the existing recording by the celebrity or well-known figure. Finally, Branch does not provide a method for contracting with a celebrity so that the celebrity greeting is customized to the end-consumer.

U.S. Patent Publication US 2011/0209365 to Marsh discloses a greeting card with music, multimedia content, and links. The Marsh greeting card plays recorded music or spoken greetings. The recording is played either when the card is opened via an activator, or it is played by manually pressing a button on the card. Most of the embodiments of the Marsh card include a CD or other digital media device, which contains a full version of the music that is played by the card. The Marsh card, however, does not include means by which a secondary message can be played in conjunction with a celebrity greeting. While Marsh does teach the use of a celebrity greeting, Marsh does not teach a method for contracting with the celebrity to provide a customized greeting.

U.S. Patent Publication US 2012/0000101 to Jin teaches a greeting card that plays a digital sound file upon activation of a contact switch. The contact switch operates by initially being separated by an insert. The insert is then removed, bringing the two arms of the contact switch together. When the two arms are in contact with each other, the electrical circuit is completed, and the greeting card's sound module plays a digital audio file. Much like the other references discussed, Jin does not provide a method for working with a celebrity to produce a customized celebrity greeting that will be included in a greeting card.

Thus, a need exists for invention that provides a method whereby an end-consumer can create a greeting card that features a customized celebrity greeting.

### SUMMARY OF THE INVENTION

The present invention is directed to a process for personalizing digital media greetings.

The process begins by recording a celebrity greeting that features a well-known figure. The well-known figure can be a real person (such as a TV or movie star, a politician, a musician, etc.), or an imaginary figure (such as a literary character, an animated figure, etc.). Once recorded, this celebrity greeting is added to a list of celebrity greetings and is stored on digital media.

In one embodiment, a consumer is presented with the list of available celebrity greetings and selects the celebrity greeting that most closely matches his desires for the resulting consumer product. The celebrity greeting can be speech, music or both. The celebrity greeting can also observe a special event. Once the consumer makes his selection, the digital media that has the selected celebrity greeting stored on it is embedded on the consumer product. The consumer product is then designed by adding pictures and text related to the celebrity greeting or the well-known figure featured in the celebrity greeting. The designed consumer product is then manufactured to the consumer's specifications, and the consumer purchases the completed consumer product.

In another embodiment, consumer products are designed and manufactured with a wide range of celebrity greetings. Each consumer product is embedded with digital media that is stored with speech, music, or both featuring a well-known figure. The consumer products are then designed with pictures and text related to the featured well-known figure. These manufactured consumer products are then presented to consumers for retail purchase.

In both embodiments, a code can be included that allows the consumer to access free information on the internet about the celebrity greeting or the well-known figure featured in the celebrity greeting. This free information can be biographies of the well-known figure, additional music, additional pictures, or other information. The code can also allow the consumer to download additional pictures, music, or films related to the celebrity greeting or the featured well-known figure.

If the well-known figure is a musician and the recorded celebrity greeting features music, the music can be a popular work by the well-known figure. Additionally, when the digital media is embedding on the consumer product in both embodiments, the digital media can include means for self-activating upon interaction with a consumer. For example, if the consumer product is a greeting card, the digital media can be embedded with means such that it self-activates when the greeting card is opened.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow-chart illustrating the steps of the claimed process for creating a consumer digital product featuring a customized celebrity greeting; and

FIG. 2 illustrates the preferred embodiment of the claimed process.

### DETAILED DESCRIPTION OF THE PREFERRED EMBODIMENTS

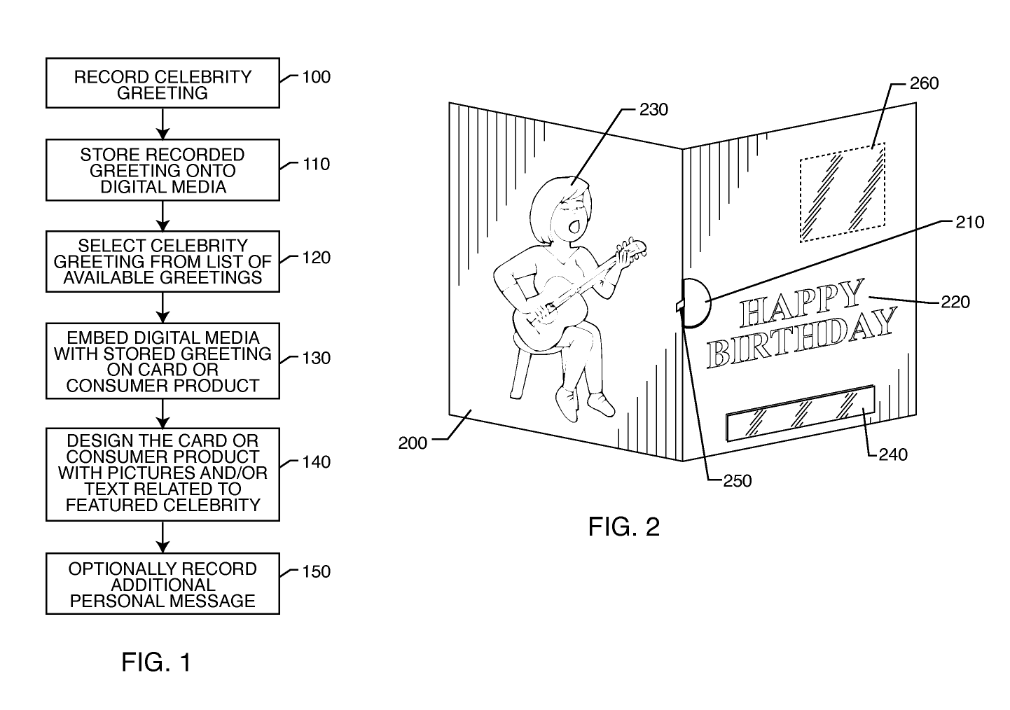

The present invention is directed to a process for creating greeting cards and other consumer products that feature a customized celebrity greeting. FIG. 1 is a flowchart illustrating the claimed method.

In box 100, the process starts by recording the celebrity greeting featuring a well-known figure. The well-known figure can be a person, such as an actor, a musician, a politician, or local figure. Well-known figures can also include animated characters, literary characters, animals, popular culture figures, political figures, characters from TV or movies, etc. The celebrity greeting can be speech, or music, or both. The celebrity greeting may include the well-known figure identifying himself/herself and giving a celebratory statement that is typical of a certain event (e.g. “Happy Birthday!”, “Merry Christmas!”, etc.). If the celebrity greeting is meant for a non-celebratory event, the celebrity greeting can include the well-known figure giving words of advice, explanation, or condolence (e.g. “I'm sorry for your loss”, etc.).

The celebrity greeting can also include music. If the featured well-known figure is a musical artist, the well-known figure may have parts of a previously published or recorded song included in the celebrity greeting. Alternatively, the well-known figure can perform the music specifically for the recorded celebrity greeting. The music can be one of the well-known figure's already popular songs, or it can be a shortened version of an already popular song (e.g. the chorus), or it can even be an improvised piece that the well-known figure made up on the spot. The celebrity greeting can begin with a spoken message from the well-known figure followed by the well-known figure's music, or vice versa.

The celebrity greeting is preferably recorded with standard recording equipment, but can also have been recorded over the phone or over the internet using VoIP, or another type of web chat. The method for recording depends largely on the well-known figure's availability. Enabling the recording to take place over the phone or internet means that customized greetings can be created using well-known figures from anywhere in the world. The recording can be a pre-existing recording if the greeting consists of a popular song that has already been recorded. The recorded greeting will preferably be in between 30 and 40 seconds, but it may be longer or shorter. Once the recording is made, an addition referring to the recordings is made to the list of available celebrity greetings.

The greeting is stored onto digital media in box 110. The digital media includes means for playing and amplifying the recording. The digital media also includes actuating means for causing the digital media to automatically activate and play the greeting. The actuating means are interactive and can be a push button, a slide switch, a motion sensor, a timer, or any other means by which the digital media can be activated. Once activated, the digital media plays the recorded greeting either once through, or on a loop. The digital media is self-powered, preferably with an on-board battery. It may also be powered with a small, on-board solar cell. The digital media is preferably small, so that it can easily be attached or embedded on greeting cards and other consumer products.

Once the celebrity greeting has been recorded and stored on digital media, a selection must be made, as in box 120. Here, the consumer is presented with the list of available celebrity greetings. This selection can be made by a manufacturer of consumer products who is creating consumer products for retail sales. Alternately, this selection can be made by a consumer who is creating a one-time specialty personalized consumer product.

The embedding step is illustrated in box 130. Here, the digital media is embedded or attached to a greeting card or other consumer product. The digital media can be embedded on a greeting card by placing the digital media in-between two pieces of card stock that form part of the greeting card. Alternatively, the digital media can be attached to the card using an adhesive (e.g. glue), adhesive tape, Velcro, or any other attaching means. If the digital media is embedded on a consumer product, the digital media can be attached with adhesive, adhesive tape, wire, string, Velcro, fabric, or any other attaching means. If the consumer product or greeting card is a one-time specialty product created by a consumer, the embedding step occurs after the product or card has been purchased. If the consumer product or greeting card is a mass produced item created by a manufacturer, the embedding step occurs before the items are purchased by end-users.

Next, the card or consumer product is designed with pictures and text, as taught in box 140. In this step, the creator of the card or product can select pictures and text that relate to the celebrity or well-known figure who is featured in the recorded greeting. The pictures can be photographs of the celebrity or well-known figure. These photographs can be posed, or they can be photographs of the celebrity or well-known figure in concert, or they can be photographs of the celebrity or well-known figure in a popular TV or movie role. The associated text can be a signature catch-phrase or slogan used by the celebrity or well-known figure. The text may also be a common greeting styled in the unique way of the celebrity or well-known figure. The text may also be an introduction to the music or speech that has been recorded on the digital device. Alternately, the creator can select pictures and text related to the event associated with the greeting card or product. The selected pictures and text may be printed directly onto the greeting card or consumer product. The selected pictures and text may also be printed on some other medium, and then attached to the greeting card or consumer product with any of the attaching means described here.

The text that is included in the greeting card or consumer gift may also include a printed code. This printed code directs the consumer to the internet. Using this code, the consumer can access more information about the featured well-known figure. The information available through the code may include a biography, more photographs, or internet hyperlinks to other websites related to the well-known figure. The code may also provide the consumer access to downloads of other songs, films, or other recordings featuring the well-known figure. Preferably, the code is printed on the greeting card or consumer product and is then covered by a thin coating of opaque material that can be easily scratched off to reveal the code. This ensures that the code is only available to a purchaser of the greeting card or consumer product.

In the final box 150, the end purchaser of the card has the further option of recording an additional personal greeting onto the embedded digital media. The personal greeting is recorded by the end purchaser by pressing a pressing a button down, or sliding a switch that allows the digital media to record an additional 10-15 seconds. The end purchaser speaks, sings, or plays into a microphone provided on the card or consumer product. The personal greeting may also be music, or a combination of speech and music. When the card or consumer product is activated, the celebrity greeting plays first and the personal greeting plays after the celebrity greeting has finished.

FIG. 2 is an illustration of the end product of the claimed method. The greeting card 200 is preferably a standard one-fold card. The greeting card 200 can also be a tri-fold card, or a horizontally hinged card. The greeting card 200 can even be a post card with no folds. The greeting card 200 is embedded with digital media 210.

The digital media 210 is small and functions in conjunction with means for recording 260, means for playing back the recording 260, and means for self-activating 250. The recording means can be an on-board microphone that records sounds directly onto the digital media 210. The recording means 260 may also be an input whereby recorded digital files can be transferred onto the digital media 210. The playback means 260 that work in conjunction with the digital media 210 may be an on-board speaker. The means for self-activating 250 the digital media 210 may be a push button, a slide switch, a motion sensor, a timer, or any other means that causes the digital media 210 to self-activate when interacted with. In the preferred embodiment, the digital media 210 is positioned on the fold of the greeting card 200, and is fitted with a slide switch. The slide switch is fastened to the opposing side of the greeting card 200 such that when the greeting card 200 is opened, the digital media 210 is activated and the stored greeting is played.

The digital media 210 may also include recording means 260 (e.g. a microphone) and storing means 210 (e.g. memory) to record and store a personal message from a consumer in addition to the greeting from the celebrity or well-known figure. If this feature is available, the consumer may record a short (10-15 second) personal message once the greeting card or product is purchased. When the digital media is later activated, the celebrity greeting plays first and is followed by the personal message.

The greeting card 200 is also printed with text 220 and pictures 230. The text 220 can be event specific (e.g., “Happy Birthday!”, “Merry Christmas!”, “Happy Valentine's Day!”, etc.) or it can be a statement written by the featured celebrity or well-known figure in their unique style. The printed text 220 can be a message of encouragement or an introduction to the recorded greeting.

The greeting card 200 may also include pictures 230. The included pictures 230 may be generic and related to the event associated with the card. More preferably, the pictures 230 may be specifically related to the featured celebrity or well-known figure from the recorded greeting. For example, the picture 230 may be a posed photograph of the featured celebrity or well-known figure. Alternatively, the picture 230 may be a photograph of the celebrity or well-known figure in concert or in character during a TV show or movie. If the celebrity or well-known figure is not a person, but rather an imaginary figure such as an animated character, the picture may be a popular rendition of the well-known figure.

The greeting card 200 may also include a printed code 240. The code is preferably covered with a thin coating of opaque material that is easily scratched off, revealing the underlying printed code 240. The scratch-off coating ensures that only the purchaser of the card or consumer product will be able to use the printed code 240. The printed code 240 gives the consumer access to more information on the internet related to the celebrity greeting or the well-known figure featured in the celebrity greeting. The consumer can use the printed code 240 to access biographies, music downloads, or even film downloads.

Finally, the means for activating the card 250 can be a button, a slide switch, a motion sensor, a timer, or any other means that responds to human interaction. The means for activating the card 250 are preferably located along the spine of the card 200, so that the digital media 210 activates when the card 200 is opened.

Although several embodiments have been described in some detail for purposes of illustration, various modifications may be made without departing from the scope and spirit of the invention. Accordingly, the invention is not to be limited, except by the appended claims.

What is claimed is:

1. A process for personalizing digital media greetings, comprising the steps of:
recording a celebrity greeting featuring a well-known figure to add to a list of celebrity greetings;
storing the celebrity greeting on digital media;
selecting the celebrity greeting from the list of celebrity greetings wherein the greeting is speech, music, or both, and observes a special event;
embedding on a consumer product the digital media stored with the selected celebrity greeting; and
adding pictures and text related to the celebrity greeting to the consumer product.

2. The process of claim 1, wherein the step of embedding on a consumer product the digital media stored with the selected celebrity greeting occurs before the consumer product is purchased.

3. The process of claim 1, wherein the step of embedding on a consumer product the digital media stored with the selected celebrity greeting occurs after the consumer product is purchased.

4. The process of claim 1, wherein the step of adding pictures and text further includes the step of providing a code to access free information on the Internet about the celebrity greeting or the well-known figure featured in the celebrity greeting.

5. The process of claim 4, wherein the step of providing a code to access free information further includes the step of enabling a user to download additional music, information, or pictures of the well-known figure.

6. The process of claim 1, wherein the step of recording the celebrity greeting further includes the step of recording music and the music comprises a popular work of the well-known figure.

7. The process of claim 1, wherein the step of embedding on the consumer product the digital media further includes the step of providing means for recording and storing a personal message from a consumer in addition to the celebrity greeting.

8. The process of claim 1, wherein the well-known figure is a real person or an imaginary figure.

9. The process of claim 1, wherein the step of embedding on the consumer product the digital media further includes the step of providing means for self-activating the digital media upon interaction with a consumer.

10. The process of claim 9, wherein the consumer product is a greeting card.

11. The process of claim 10, wherein the step of providing means for self-activating the digital media further includes the step of embedding the digital media such that the digital media self-activates when the greeting card is opened.

12. The process of claim 1, further including the step of enabling the end-user to record and store a personal greeting on the digital media.

13. A process for personalizing digital media greetings, comprising the steps of:
recording a celebrity greeting featuring a well-known figure to add to a list of celebrity greetings;
storing the celebrity greeting on digital media;
selecting the celebrity greeting from the list of celebrity greetings wherein the greeting is speech, music, or both and comprises a popular work of the well-known figure;
embedding on a consumer product the digital media stored with the selected celebrity greeting;
adding pictures, text, and a code related to the celebrity greeting to the consumer product, wherein the code enables access to free information on the internet about the celebrity greeting or the well-known figure; and
providing means for recording and storing a personal message from a consumer in addition to the celebrity greeting.

14. The process of claim 13, wherein the consumer product is a greeting card.

15. The process of claim 13, wherein the step of adding a code to access free information further includes the step of enabling a user to download additional music, information, or pictures of the well-known.

16. The process of claim 13, wherein the step of recording the celebrity greeting further includes the step of recording music and the music comprises a popular work of the well-known figure.

17. The process of claim 13, wherein the well-known figure is a real person or an imaginary figure.

18. The process of claim 14, wherein the step of embedding on the consumer product the digital media further includes the step of providing means for self-activating the digital media upon interaction with a consumer.

19. The process of claim 18, wherein the step of providing means for self-activating the digital media further includes the step of embedding the digital media such that the digital media self-activates when the greeting card is opened.

20. A process for personalizing digital media greetings, comprising the steps of:
recording a celebrity greeting featuring a well-known figure to add to a list of celebrity greetings;
storing the celebrity greeting on digital media;
selecting the celebrity greeting from the list of celebrity greetings, wherein the well-known figure is a real person or an imaginary figure, wherein the greeting is speech, music, or both and comprises either a popular song by the well-known figure that has been previously recorded, or an improvised piece created by the well-known figure at the time of recording;
embedding on a greeting card the digital media stored with the selected celebrity greeting;
adding pictures, text, and a code related to the celebrity greeting or well-known figure to the greeting card wherein the code enables access to free information on the internet about the celebrity greeting or the well-known figure and the free information includes biographies, additional pictures, and music or film downloads; and
enabling the end-user to record and store a personal greeting on the digital media.

21. The process of claim 20, wherein the step of embedding on the greeting card the digital media further includes the step of providing means for self-activating the digital media upon interaction with a consumer.
